(19) United States
(12) Patent Application Publication
(10) Pub. No.: US 2023/0054111 A1
(43) Pub. Date: Feb. 23, 2023

(54) RANDOM ACCESS PROCEDURE FOR FULL-DUPLEX OPERATION

(71) Applicant: Samsung Electronics Co., Ltd., Suwon-si (KR)

(72) Inventors: Marian Rudolf, Longueuil (CA); Aristides Papasakellariou, Houston, TX (US); Carmela Cozzo, San Diego, CA (US)

(21) Appl. No.: 17/813,581

(22) Filed: Jul. 19, 2022

Related U.S. Application Data
(60) Provisional application No. 63/229,157, filed on Aug. 4, 2021.

(51) Int. Cl. H04W 74/08; H04W 72/04

(52) U.S. Cl. CPC H04W 74/0833; H04W 72/0446

(57) ABSTRACT

Apparatuses and methods for random access procedure for full-duplex operation. A method for a user equipment includes receiving first information for first parameters of a first random-access channel (RACH) configuration associated with a first subset of slots from a set of slots on a cell and second information for second parameters of a second RACH configuration associated with a second subset of slots from the set of slots on the cell. The method further includes determining a RACH configuration, among the first and second RACH configurations, for a physical random-access channel (PRACH) transmission in a slot on the cell based on whether the slot is from the first subset of slots or the second subset of slots and transmitting the PRACH in the slot on the cell based on the determined RACH configuration.

### CROSS-REFERENCE TO RELATED APPLICATION AND CLAIM OF PRIORITY

This application claims priority under 35 U.S.C. § 119(e) to U.S. Provisional Patent Application No. 63/229,157 filed on Aug. 4, 2021. The above-identified provisional patent application is hereby incorporated by reference in its entirety.

### TECHNICAL FIELD

The present disclosure relates generally to wireless communication systems and, more specifically, the present disclosure relates to random access procedure for full-duplex operation.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to random access procedure for full-duplex operation in 5G NR.

In one embodiment, a method is provided. The method includes receiving first information for first parameters of a first random-access channel (RACH) configuration associated with a first subset of slots from a set of slots on a cell and second information for second parameters of a second RACH configuration associated with a second subset of slots from the set of slots on the cell. The method further includes determining a RACH configuration, among the first and second RACH configurations, for a physical random-access channel (PRACH) transmission in a slot on the cell based on whether the slot is from the first subset of slots or the second subset of slots and transmitting the PRACH in the slot on the cell based on the determined RACH configuration.

In another embodiment, a user equipment (UE) is provided. The UE includes a transceiver configured to receive first information for first parameters of a first RACH configuration associated with a first subset of slots from a set of slots on a cell and second information for second parameters of a second RACH configuration associated with a second subset of slots from a set of slots on a cell. The UE further includes a processor operably coupled to the transceiver. The processor is configured to determine a RACH configuration, among the first and second RACH configurations, for a PRACH transmission in a slot on the cell based on whether the slot is from the first subset of slots or the second subset of slots. The transceiver is further configured to transmit the PRACH in the slot on the cell based on the determined RACH configuration.

In yet another embodiment, a base station is provided. The base station includes a transceiver configured to transmit first information for first parameters of a first RACH configuration associated with a first subset of slots from a set of slots on a cell and second information for second parameters associated with a second RACH configuration associated with a second subset of slots from the set of slots on the cell. The base station further includes a processor operably coupled to the transceiver. The is processor configured to determine a RACH configuration for reception of a PRACH in a slot on the cell based on whether the slot is from the first subset of slots or the second subset of slot. The transceiver is further configured to receive the PRACH in the slot based on the determined RACH configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example diagram of an example physical random-access channel (PRACH) time- and frequency-domain allocation according to embodiments of the present disclosure;

FIG. 7 illustrates an example diagram of an example E/R/R/BI MAC sub-header according to embodiments of the present disclosure;

FIG. 8 illustrates an example diagram of an example E/T/RAPID Medium Access Control (MAC) sub-header according to embodiments of the present disclosure;

FIG. 9 illustrates an example diagram of an example MAC random access response (RAR) according to embodiments of the present disclosure;

FIG. 10 illustrates an example diagram of a time division duplexing (TDD) communication system according to embodiments of the present disclosure;

FIG. 11 illustrates an example diagram of two example full-duplex communication system configurations according to the embodiments of the present disclosure;

FIG. 12 illustrates an example diagram of example random access channel (RACH) configurations in a full-duplex communication system according to the embodiments of the present disclosure;

FIG. 13 illustrates an example a diagram of PRACH resource selection configuration using reference signal received power (RSRP) according to embodiments of the present disclosure;

FIG. 14 illustrates an example method for PRACH resource selection processing chain using RSRP according to embodiments of the present disclosure;

FIG. 15 illustrates an example diagram of an example determination and use of RACH configuration according to the embodiments of the present disclosure; and

FIG. 16 illustrates an example diagram of an example PRACH allocation and configuration according to embodiments of the present disclosure.

### DETAILED DESCRIPTION

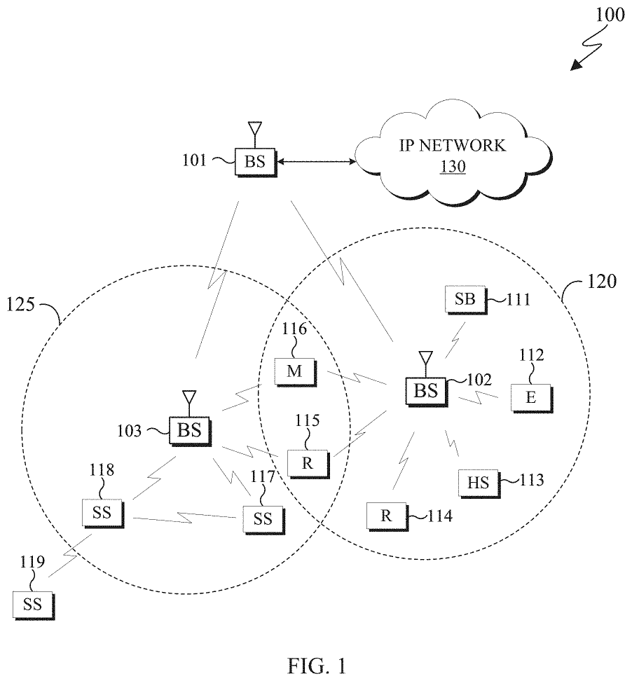

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents are hereby incorporated by reference into the present disclosure as if fully set forth herein: 3GPP TS 38.211 v16.6.0, “NR; Physical channels and modulation;” 3GPP TS 38.212 v16.6.0, “NR; Multiplexing and Channel coding” (REF1); 3GPP TS 38.213 v16.6.0, “NR; Physical Layer Procedures for Control;” (REF2); 3GPP TS 38.214 v16.6.0, “NR; Physical Layer Procedures for Data” (REF3); 3GPP TS 38.321 v16.5.0, “NR; Medium Access Control (MAC) protocol specification” (REF4); and 3GPP TS 38.331 v16.5.0, “NR; Radio Resource Control (RRC) Protocol Specification” (REFS).

To meet the demand for wireless data traffic having increased since deployment of the fourth generation (4G) communication systems, efforts have been made to develop and deploy an improved 5th generation (5G) or pre-5G/NR communication system. Therefore, the 5G or pre-5G communication system is also called a “beyond 4G network” or a “post long-term evolution (LTE) system.”

The 5G communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, vehicular (V2X), device-to-device (D2D) communication, wireless backhaul (IAB), moving network, cooperative communication, coordinated multi-points (CoMP), reception-end interference cancelation, multi-transmit-receive point (multi-TRP), cross-link (CLI) and remote interference (RIM) detection and avoidance, and NR operation in unlicensed bands (NR-U) and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Depending on the network type, the term ‘base station’ (BS) can refer to any component (or collection of components) configured to provide wireless access to a network, such as transmit point (TP), TRP, an enhanced base station (eNodeB or eNB), a gNB, a macrocell, a femtocell, a WiFi access point (AP), a satellite, or other wirelessly enabled devices. Base stations may provide wireless access in accordance with one or more wireless communication protocols, e.g., 5G 3GPP New Radio Interface/Access (NR), LTE, LTE advanced (LTE-A), High Speed Packet Access (HSPA), Wi-Fi 802.11a/b/g/n/ac, etc. The terms ‘BS,’ ‘gNB,’ and ‘TRP’ can be used interchangeably in this disclosure to refer to network infrastructure components that provide wireless access to remote terminals. Also, depending on the network type, the term ‘user equipment’ (UE) can refer to any component such as mobile station, subscriber station, remote terminal, wireless terminal, receive point, vehicle, or user device. For example, a UE could be a mobile telephone, a smartphone, a monitoring device, an alarm device, a fleet management device, an asset tracking device, an automobile, a desktop computer, an entertainment device, an infotainment device, a vending machine, an electricity meter, a water meter, a gas meter, a security device, a sensor device, an appliance, and the like.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station, BS 101 (e.g., gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipment's (UEs) within a coverage area 120 of the BS 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for random access procedure for full-duplex operation. In certain embodiments, and one or more of the BSs 101-103 includes circuitry, programing, or a combination thereof for random access procedure for full-duplex operation.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

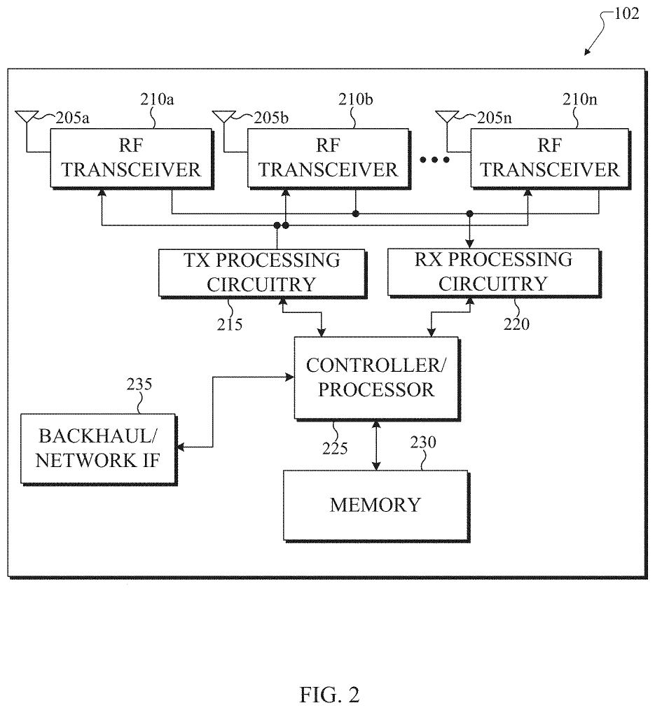

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple radio frequency (RF) transceivers 210a-210n, transmit (TX) processing circuitry 215, and receive (RX) processing circuitry 220. The BS 102 also includes a controller/processor 225, a memory 230, and a backhaul or network interface 235.

The RF transceivers 210a-210n receive, from the antennas 205a-205n, incoming RF signals, such as signals transmitted by UEs in the wireless network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antenna 205a-205n are weighted differently to effectively steer the outgoing signals in a desired direction. Any of a wide variety of other functions could be supported in the BS 102 by the controller/processor 225. In some embodiments, the controller/processor 225 includes at least one microprocessor or microcontroller.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The network interface 235 could support communications over any suitable wired or wireless connection(s). For example, when the BS 102 is implemented as part of a cellular communication system (such as one supporting 5G/NR, LTE, or LTE-A), the network interface 235 could allow the BS 102 to communicate with other BSs over a wired or wireless backhaul connection. When the BS 102 is implemented as an access point, the network interface 235 could allow the BS 102 to communicate over a wired or wireless local area network or over a wired or wireless connection to a larger network (such as the Internet). The network interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. As a particular example, an access point could include a number of network interfaces 235, and the controller/processor 225 could support routing functions to route data between different network addresses. As another particular example, while shown as including a single instance of TX processing circuitry 215 and a single instance of RX processing circuitry 220, the BS 102 could include multiple instances of each (such as one per RF transceiver). Also, various components in FIG. 2 could be combined, further subdivided, or omitted and additional components could be added according to particular needs.

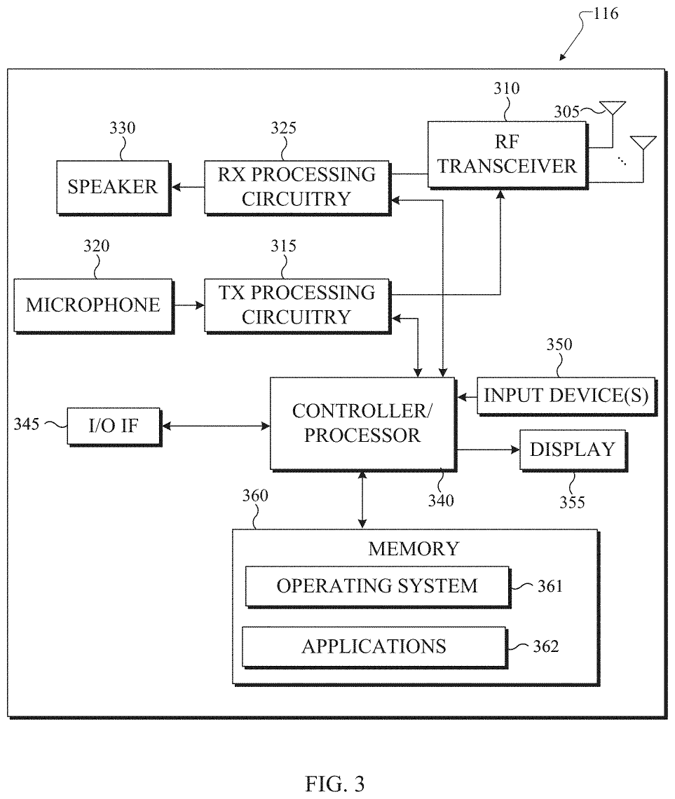

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a RF transceiver 310, TX processing circuitry 315, a microphone 320, and receive (RX) processing circuitry 325. The UE 116 also includes a speaker 330, a processor 340, an input/output (I/O) interface (IF) 345, an input device 350, a display 355, and a memory 360. The memory 360 includes an operating system (OS) 361 and one or more applications 362.

The RF transceiver 310 receives, from the antenna 305, an incoming RF signal transmitted by a BS of the wireless network 100. The RF transceiver 310 down-converts the incoming RF signal to generate an intermediate frequency (IF) or baseband signal. The IF or baseband signal is sent to the RX processing circuitry 325 that generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of uplink channel signals and the transmission of downlink channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input device 350. The operator of the UE 116 can use the input device 350 to enter data into the UE 116. The input device 350 can be a keyboard, touchscreen, mouse, track ball, voice input, or other device capable of acting as a user interface to allow a user in interact with the UE 116. For example, the input device 350 can include voice recognition processing, thereby allowing a user to input a voice command. In another example, the input device 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 340 is also coupled to the display 355. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

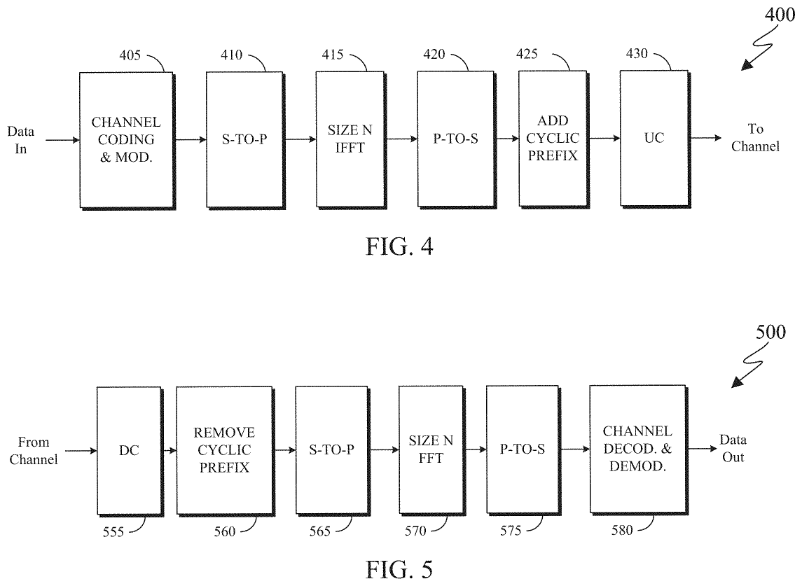

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support UL reference signal-based beam management as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system includes a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB (such as the BS 102) transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE (such as the UE 116) can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

UL signals also include data signals conveying information content, control signals conveying UL control information (UCI), DM-RS associated with data or UCI demodulation, sounding RS (SRS) enabling a gNB to perform UL channel measurement, and a random access (RA) preamble enabling a UE to perform random access (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE (such as the UE 116) has data in a buffer, and CSI reports enabling a gNB (such as the BS 102) to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same pre-coding resource group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronized signal (SS)/PBCH (SS/PBCH is also denoted as SSB) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that SSBs transmitted with the same block index on the same center frequency location are quasi co-located with respect to Doppler spread, Doppler shift, average gain, average delay, delay spread, and, when applicable, spatial Rx parameters. The UE may not assume quasi co-location for any other SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group are quasi co-located with respect to Doppler shift, Doppler spread, average delay, delay spread, and spatial Rx. The UE may also assume that DM-RS ports associated with a PDSCH are quasi co-located (QCL) with QCL type A, type D (when applicable) and average gain. The UE may further assume that no DM-RS collides with the SS/PBCH block.

In certain embodiments, the UE (such as the UE 116) can be configured with a list of up to M transmission configuration indication (TCI)—State configurations within the higher layer parameter PDSCH-Config to decode PDSCH according to a detected PDCCH with DCI intended for the UE and the given serving cell, where M depends on the UE capability maxNumberConfiguredTClstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE (such as the UE 116) can receive a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot e.g., n+3Nₛₗₒₜ^{subframe,μ}.

An RA procedure is initiated by on the following methods: RRC (for SI-request)—if SIB1 includes scheduling info for (on-demand) SI request; MAC; and PDCCH-order.

A random access procedure can be initiated due to at least one of the following triggers/purposes: (1) initial access to establish RRC connection (to go from RRC_IDLE to RRC_CONNECTED); (2) re-establish RRC connection after radio link failure (RLF); (3) on-demand system information (SI) request; (4) hand-over; (5) UL synchronization; (6) scheduling request; (7) positioning; and (8) link recovery—also known as beam failure recovery (BFR).

RA can operate in two modes: (i) contention-based random access (CBRA) where UEs within a serving cell can share same RA resources and there is therefore a possibility of collision among RA attempts from different UEs, and (ii) contention-free random access (CFRA) where a UE has dedicated RA resources that are indicated by a serving gNB and may not be shared with other UEs so that RA collisions can be avoided. For example, CBRA may be used for all triggers/purposes mentioned above while CFRA may be used only for triggers/purposes (4) through (8) as shown above.

A 4-step random access procedure, also known as a Type-1 (L1) random access procedure, consists of the following steps/operations for a UE: (i) transmission of a PRACH preamble (Msg1); (ii) attempting to receive a random-access response (RAR or Msg2); (iii)transmitting a contention resolution message (Msg3); and (iv) attempting to receive a contention resolution message (msg4).

An alternative random-access procedure can be also considered, which is so-called 2-step RACH or a Type-2 L1 random access procedure, where Msg1 and Msg3 are combined into a “MsgA” transmission and Msg2 and Msg4 above are combined into a “MsgB” reception.

Various embodiments of the disclosure involve 4-step RACH, although the embodiments can generally apply to 2-step RACH as well and explicit individual descriptions are typically omitted for brevity.

A PRACH preamble transmission (for both CBRA and CFRA modes) is associated with a DL RS. This association can help a serving gNB to identify an uplink spatial reception filter/beam to receive a PRACH and can also help a UE to identify an uplink spatial transmission filter/beam to transmit a PRACH. For example, a UE can use a same or a related, such as with same quasi-colocation (QCL) properties and/or same direction but narrower width, uplink transmission filter/beam as that used for DL reception of an indicated DL RS for Msg1 transmission. This association can also be used to provide a DL RS resource for pathloss estimation for determining a PRACH preamble transmission power in NR specification.

A DL RS for Msg1 transmission can be one of the following options based on the PRACH scenario: SSB: for BFR, CFRA, PDCCH-order PRACH, SI request, CBRA; or CSI-RS: for BFR, CFRA, CBRA.

Throughout the disclosure, an SSB is used as a short form for a SS/PBCH block. The terms SSB and SS/PBCH block are interchangeably used in this disclosure.

Furthermore, it is possible for a serving cell to be configured with both SSB and CSI-RS for PRACH transmissions. For example, some PRACH preambles can be associated with an SSB for QCL determination and some PRACH preambles can be associated with a CSI-RS for QCL determination. It is also possible that a secondary serving cell (SCell) does not have any SSB configuration/transmission and only supports PRACH transmissions from UEs using CSI-RS for QCL determination. Then, as described in the previous paragraph, certain random-access triggers/modes such as for PDDCH-order PRACH or for SI request, are not applicable.

A RACH configuration includes RACH occasions (ROs) in certain RACH slots and certain frequency resource blocks, that repeat with a certain periodicity.

NR uses Zadoff-Chu sequences for the PRACH preambles. There are 3 PRACH long preamble formats with sequence length of 839 with subcarrier spacings of 1.25 or 5 kHz. Long sequences support unrestricted sets and restricted sets of Type A and Type B. For the purpose of beam-sweeping within a RACH occasion, NR uses a new set of PRACH preamble formats of shorter sequence length 139 on 1, 2, 4, 6, and 12 OFDM symbols and SCS of 15, 30, 60, and 120 kHz. These are composed of single or consecutive repeated RACH sequences. The cyclic prefix is inserted at the beginning of the preambles. Guard time is appended at the end of the preambles, while cyclic prefix and gap between RACH sequences is omitted. Short sequences support unrestricted sets only. For both short and long PRACH preamble sequences, the network can also conduct beam-sweeping reception between RACH occasions.

Multiple RACH preamble formats are defined for one or more PRACH symbols. Possibly different CP and GT lengths can be used. PRACH preamble configuration is signaled to the UE by RRC. A UE calculates the PRACH transmit power for the retransmission of the preamble based on the most recent estimate of pathloss and the power ramping counter. If the UE conducts beam switching, the counter for power ramping doesn't change. RRC informs the UE of the association between the SSB and RACH resources. The threshold of the SSB for RACH resource association is based on the RSRP and configurable by the network.

Before a RACH preamble transmission, the physical layer of a UE receives a set of SSB indices and provides the UE RRC sublayer a set of RSRP measurements for SSB candidates with the indices. Information required for the UE physical layer prior to PRACH preamble transmission includes preamble format, time resources, and frequency resources for PRACH transmission as well as parameters for determining root sequences and their cyclic shifts in the PRACH preamble sequence set including index to logical root sequence table, cyclic shift NCS, and set type, that is, unrestricted, restricted set A, or restricted set B.

SSB indices are mapped to PRACH occasions in increasing order of preamble indices within a single PRACH occasion then, in increasing order of frequency resource indices of frequency-multiplexed PRACH occasions, then, in increasing order of time resource indices of time-multiplexed PRACH occasions within a PRACH slot and, finally, in increasing order of indices of PRACH slots. An association period, starting from frame 0, for mapping SSBs to PRACH occasions is a smallest value in a set determined by the PRACH configuration period such that N_{SSB} SS/PBCH blocks are mapped at least once to PRACH occasions within the association period. A UE obtains the parameter N_{SSB} from RRC. If after an integer number of SSB to PRACH occasions mapping cycles within the association period, there is a set of PRACH occasions that are not mapped to N_{SSB} SSBs, no SSBs are mapped to the set of PRACH occasions. An association pattern period includes one or more association periods and is calculated such that a pattern between PRACH occasions and SSBs repeats at most every 160 msec. PRACH occasions that are not associated with SSBs after an integer number of association periods, if any, are not used for PRACH transmissions.

A PRACH preamble transmission can occur within a configurable subset of slots that are referred to as PRACH slots and repeat every PRACH configuration period. There may be multiple PRACH occasions within each PRACH slot in the frequency-domain that cover NRBPRACH-Preamble NPRACH consecutive RBs where NRBPRACH-Preamble is a preamble bandwidth measured in number of RBs, and NPRACH is the number of frequency-domain PRACH occasions.

A next available PRACH occasion from PRACH occasions corresponding to a selected SSB may be further restricted by a parameter ra-ssb-OccasionMasklndex, if configured or indicated by PDCCH. Otherwise, the UE MAC selects a PRACH occasion randomly with equal probability amongst consecutive PRACH occasions. Measurement gaps when determining a next available PRACH occasion corresponding to a selected SSB are also be accounted for. Similar, parameter ra-OccasionList may restrict PRACH occasion(s) when associated with a CSI-RS where a PRACH preamble may be transmitted.

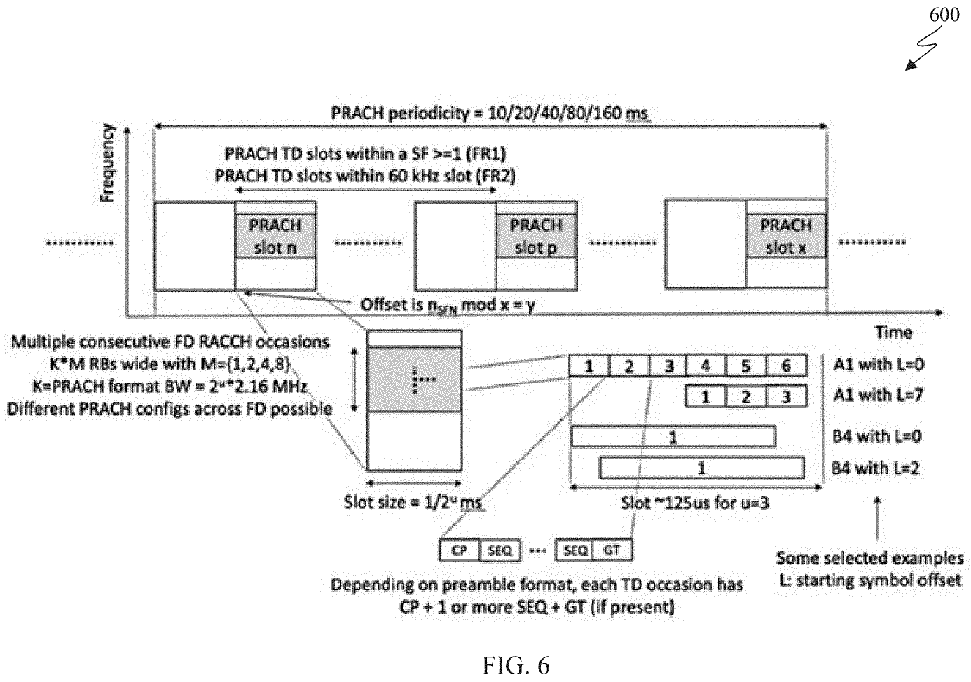

FIG. 6 illustrates an example diagram 600 of an example PRACH time-domain and frequency-domain allocation and parameter configuration according to embodiments of the disclosure. The diagram 600 is for illustration only and other embodiments can be used without departing from the scope of the present disclosure.

For a given preamble type, corresponding to a certain preamble bandwidth, the overall available time-frequency PRACH resources within a cell can be described by the following parameters: a configurable PRACH periodicity that can range from 10 to 160 msec; a configurable set of PRACH slots within the PRACH period; and a configurable frequency-domain PRACH resource given by the index of the first RB in the resource and the number of frequency-domain PRACH occasions.

A UE can transmit PRACH preambles only in time resources that are signaled via RRC parameter prach-Configurationlndex and further depend on the frequency range (FR1 or FR2) and the spectrum type. A UE can transmit PRACH preambles only in frequency resources indicated by parameter msg1-FrequencyStart. The PRACH frequency resources nRA={0; 1; . . . ; M-1}, in which the parameter M is derived from the RRC parameter msg1-FDM, are numbered in increasing order within an initial active UL bandwidth part during initial access, starting from the lowest frequency. In addition to measured SSB, determination of PRACH preamble transmission power requires knowledge of parameter PREAMBLE_RECEIVED_TARGET_POWER signaled via RRC for an active UL BWP on the carrier.

Following RACH preamble transmission, if within a random access response window of RRC signaled and configurable size ra-Response Window (e.g., up to 10 msec), the UE does not receive a random access response that contains a random access preamble identifier (RAPID) corresponding to the preamble sequence transmitted by the UE, the UE typically increases (in steps) a transmission power up to a certain limit, such as one defined by a maximum transmission power, using a power ramping counter for a subsequent PRACH transmission. If prior to a PRACH retransmission, the UE changes a spatial domain transmission filter, the UE physical layer notifies the higher layers to suspend the power ramping counter.

After a UE transmits a PRACH preamble (Msg1), there are three more steps for a (4-step) random access procedure for the UE: reception of a random-access response (RAR or Msg2) from the gNB; transmission of a contention resolution message to the gNB (Msg3); and reception of a contention resolution response message (Msg4) from the gNB.

Random access response (RAR or Msg2) is a PDCCH/PDSCH reception on a DL BWP of a PCell/SpCell, as described below, that is the initial DL BWP (for the case of initial access, i.e., (re—)establishing RRC connection), or the active DL BWP (with same BWP-index as the active UL BWP) (for other random-access triggers except for initial access). If the active DL BWP index is not same as active UL BWP index, the UE changes the active DL BWP to one with same BWP index as the active UL BWP.

The SCS for a PDCCH reception scheduling a PDSCH with a RAR message is the SCS of a Type1-PDCCH common search space (CSS) set as described in REF 3. The SCS for any subsequent PDCCH/PDSCH reception is also same as the SCS for the PDCCH/PDSCH providing the RAR unless the UE is configured a different SCS.

A UE monitors PDCCH for detection of a DCI format 1_0 scheduling a PDSCH providing a RAR during a configured time window according to the Type1-PDCCH CSS set of the PCell/SpCell identified by a RA radio network temporary identifier (RNTI) (or, for the case of beam failure recovery (BFR) with CFRA, in the search space indicated by recoverySearchSpaceld of the PCell/SpCell identified by the cell-RNTI (C-RNTI)).

A RAR includes information for one or more UEs, wherein some of the information is common to UEs and remaining information is UE-specific.

In one example, a RAR includes a 4-bit backoff indicator (BI) that indicates a maximum back-off time needed before a next PRACH transmission attempt by a UE. The UE selects an actual back-off time uniformly at random between zero and the value indicated by the BI field. The BI is typically used to control loading of PRACH preamble transmissions on the serving cell.

In another example, a RAR includes a random-access preamble ID (RAPID), such as by a 6-bit field, that indicates an ID of a preamble that a UE transmitted and is a response to a system information (SI) request by the UE.

In another example, a gNB sends a RAPID together with a MAC payload (MAC RAR), that includes a timing advance (TA) command, an uplink grant for scheduling a Msg3 PUSCH, and a temporary C-RNTI (TC-RNTI).

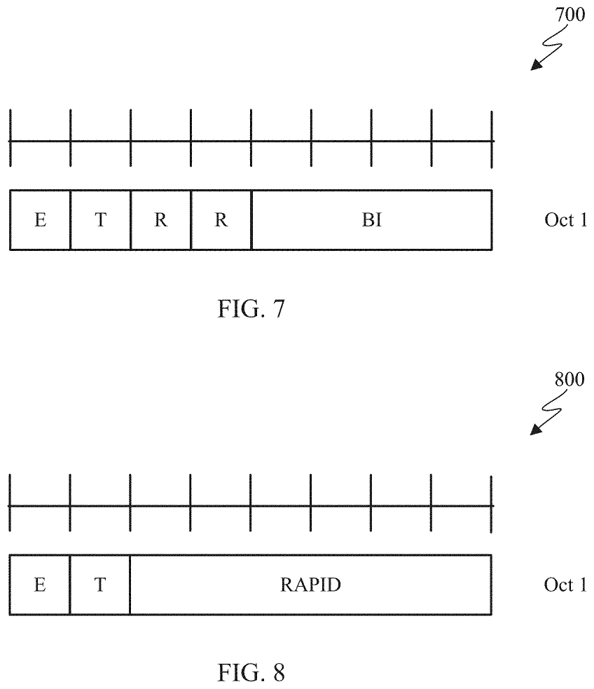

FIG. 7 illustrates an example diagram 700 of an example E/T/R/R/BI MAC sub-header according to embodiments of the disclosure. The diagram 700 is for illustration only and other embodiments can be used without departing from the scope of the present disclosure. For example, an embodiment of the E/R/R/BI MAC sub-header shown in FIG. 7 is for illustration only.

One or more of the components illustrated in FIG. 7 can be implemented in specialized circuitry configured to perform the noted functions or one or more of the components can be implemented by one or more processors executing instructions to perform the noted functions. Other embodiments are used without departing from the scope of the disclosure.

FIG. 8 illustrates an example diagram 800 of an example E/T/RAPID MAC sub-header according to embodiments of the disclosure. The diagram 800 is for illustration only and other embodiments can be used without departing from the scope of the present disclosure. For example, an embodiment of the E/T/RAPID MAC sub-header shown in FIG. 8 is for illustration only.

One or more of the components illustrated in FIG. 8 can be implemented in specialized circuitry configured to perform the noted functions or one or more of the components can be implemented by one or more processors executing instructions to perform the noted functions. Other embodiments are used without departing from the scope of the disclosure.

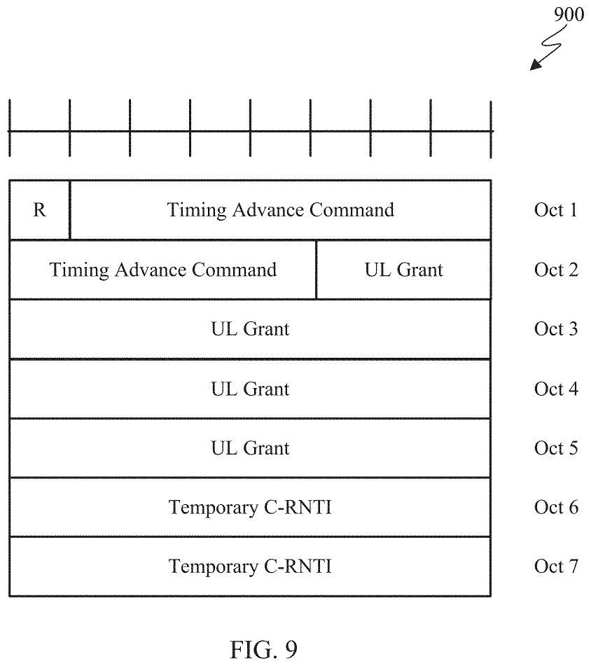

FIG. 9 illustrates an example diagram 900 of an example MAC RAR according to embodiments of the disclosure. The diagram 900 is for illustration only and other embodiments can be used without departing from the scope of the present disclosure. An embodiment of the MAC RAR 670 shown in FIG. 9 is for illustration only.

One or more of the components illustrated in FIG. 9 can be implemented in specialized circuitry configured to perform the noted functions or one or more of the components can be implemented by one or more processors executing instructions to perform the noted functions. Other embodiments are used without departing from the scope of the disclosure.

TABLE (1) describes MAC RAR grant field sizes and includes exemplary random access response grant content fields and corresponding sizes.

TABLE 1

| RAR grant field | Number of bits |
|---|---|
| Frequency hopping flag | 1 |
| PUSCH frequency resource | 14 |
| allocation | |
| PUSCH time resource allocation | 4 |
| MCS | 4 |
| Transmit power control (TPC) | 3 |
| command for PUSCH | |
| CSI request | 1 |
| Total number of bits | 27 |

For CFRA-based BFR, a UE considers a RAR reception to be successful when the UE receives a PDSCH that scheduled by a DCI format with cyclic redundancy check (CRC) scrambled by the C-RNTI for the UE that is provided by a PDCCH reception according to an indicated search space set.

For other cases (such as CBRA and SI request), RAR is successful for a UE when the UE: (i) receives a PDCCH, according to a Type1-PDCCH CSS set of the SpCell during a configured time window, that provides a DCI format addressed to the RA-RNTI; and (ii) correctly decodes a transport block in a PDSCH scheduled by the DCI format; and (iii) obtains a same RAPID from the MAC RAR in the PDSCH as the RAPID for a transmitted PRACH preamble in Msg1. Then, the UE, for the serving cell where the UE transmitted PRACH preamble/Msg1, applies the TA to adjust a timing between transmissions and receptions, stores a TC-RNTI provided by the MAC RAR for use in future transmissions/receptions, and processes the RAR UL grant to transmit Msg3 PUSCH.

If RAR reception by a UE is not successful, the UE attempts (possibly after a back-off and/or UE processing time up to N_{T,1}+0.75 msec as described in REF 3) a new PRACH preamble transmission with PRACH resource selection (possibly including a different SSB and/or a different preamble), and possibly by applying PRACH preamble power ramping, unless the UE has reached a configured maximum number of PRACH attempts and then the UE reports a random access problem to higher layers and stops the RA procedure.

The resource allocation for Msg3 PUSCH (as indicated by the RAR UL grant) includes the following fields from Table (1): a frequency hopping flag; a PUSCH time resource allocation; and a PUSCH frequency resource allocation.

The time resource allocation field indicates a starting symbol and time-domain length of the Msg3 PUSCH transmission.

The frequency domain resource allocation field is for uplink resource allocation type 1 and indicates allocations of consecutive (virtual) resource blocks as described in REF 3.

In the disclosure, the terms “4-step RA”, “type-1 RA procedure” and “type-1 L1 RA procedure” are used interchangeably. Also, the terms “2-step RA”, “type-2 RA procedure” and “type-2 L1 RA procedure” are used interchangeably.

Prior to initiation of a physical random access (RA) procedure by a UE, layer 1 of the UE receives from higher layers an indication to perform a type-1 RA procedure (4-step RA) or a type-2 RA procedure (2-step RA).

From the physical layer perspective, the type-2 L1 RA procedure includes transmission of a RA preamble in a PRACH and of a PUSCH (MsgA), and the reception of a RAR message with a PDCCH/PDSCH (MsgB). When a RAR for a 2-step RA procedure indicates fall-back to 4-step RA (namely, a fallbackRAR), a 2-step RA procedure continues similar to a 4-step RA procedure, namely, a PUSCH transmission scheduled by a RAR UL grant, and a PDSCH reception for contention resolution.

PRACH preambles for a 2-step RA are separate from PRACH preambles for 4-step RA, for example, R contention-based preambles per SS/PBCH block per valid PRACH occasion for a 2-step RA procedure start after the ones for a 4-step RA procedure.

RACH occasions (ROs) for a 2-step RA procedure can be common/shared with or can be separate from ROs for a 4-step RA procedure.

In response to a transmission of a PRACH and a PUSCH, a UE attempts to detect a DCI format 1_0 with CRC scrambled by a corresponding RA-RNTI/MsgB-RNTI during a window controlled by higher layers, for example as described in REF 3 and REF 4. The window starts at a first symbol of an earliest control resource set (CORESET) the UE is configured to receive PDCCH according to Type1-PDCCH CSS set, for example as described in REF 3, that is at least one symbol after a last symbol of a PUSCH occasion corresponding to a PUSCH transmission (associated with a 2-step RA procedure), where the symbol duration corresponds to the SCS for the Type1-PDCCH CSS set. The length of the window in number of slots, based on the SCS for Type1-PDCCH CSS set, is provided by ra-ResponseWindow (as used for 4-step RA procedure) or a separate configuration can be provided for a time window length of a 2-step RA procedure.

If the UE detects the DCI format 1_0 with CRC scrambled by the corresponding RA-RNTI/MsgB-RNTI, and a transport block in a corresponding PDSCH within the window, the UE passes the transport block to higher layers.

The higher layers indicate to the physical layer one of (a) an uplink grant when the RAR message(s) is for fallbackRAR and a RAPID associated with the PRACH transmission is identified, and the UE procedure continues as in a 4-step RA procedure when the UE detects a RAR UL grant, or (b) an ACK to be provided in a PUCCH transmission when the RAR message(s) is for successRAR. When the UE transmits a PUCCH that provides an ACK, a PUCCH resource for the PUCCH transmission is indicated by a PUCCH resource indicator (PRI) field of 4 bits in the successRAR from a PUCCH resource set that is provided by pucch-ResourceCommon; a slot for the PUCCH transmission is indicated by a PDSCH-to-HARQ feedback timing indicator field of 3 bits in the successRAR having a value k from {1, 2, 3, 4, 5, 6, 7, 8} and, with reference to slots for PUCCH transmission having duration Tₛₗₒₜ, the slot is determined as ceil (n+k+Δ+t_{Δ}/Tₛₗₒₜ), where n is a slot of the PDSCH reception, Δ is for example as defined for PUSCH transmission in REF 3 or per a different table provided in the system specifications, and t_{Δ}≥0. The UE does not expect a first symbol of the PUCCH transmission to be after a last symbol of the PDSCH reception by a time smaller than N_{T,1}+0.5+t_{Δ} msec where N_{T,1} is a PDSCH processing time for UE processing capability 1 as described in REF 4. The PUCCH transmission is with a same spatial domain transmission filter and in a same active UL BWP as a last PUSCH transmission.

If the UE detects the DCI format 1_0 with CRC scrambled by a C-RNTI and a transport block in a corresponding PDSCH within the window, the UE transmits a PUCCH with HARQ-ACK information having ACK value when the UE correctly detects the transport block or having negative acknowledgement (NACK) value when the UE incorrectly detects the transport block, and the time alignment timer is running.

The UE does not expect to be indicated to transmit the PUCCH with the HARQ-ACK information at a time that is prior to a time when the UE applies a TA command that is provided by the transport block.

If the UE does not detect the DCI format 1_0 with CRC scrambled by the corresponding RA-RNTI/MsgB-RNTI within the window, or if the UE does not correctly receive the transport block in the corresponding PDSCH within the window, or if the higher layers do not identify the RAPID associated with the PRACH transmission from the UE, the higher layers can indicate to the physical layer to perform a Type-1 RA procedure or to perform a Type-2 RA procedure.

If requested by higher layers, the UE is expected to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 when additional PDSCH DM-RS is configured. For μ=0, the UE assumes N_{1,0}=14 as described in REF 3 and REF 4.

For CFRA, as well as for SI request, a correct reception of Msg2/RAR is the last step for a RA procedure. However, for CBRA, it is likely that multiple UEs may have used a same preamble and further steps are needed to resolve the contention. Furthermore, for random access before RRC_CONNECTED state, such as for initial access, a UE and a gNB need to exchange further information to set up the connection and an Msg3 PUSCH transmission is needed for contention resolution request and possibly also for connection setup request, and a Msg4 PDSCH transmission is needed for contention resolution response and possibly for connection setup response. The contention resolution (and connection set up, if applicable) is considered successful if the UE receives Msg4 PDSCH within a certain time window after transmission of Msg3 and, when the UE has not received a C-RNTI, also if the contention resolution ID in Msg4 PDSCH matches the ID that the UE transmitted in Msg3 PUSCH. Otherwise, the contention resolution Msg¾, and therefore the RA attempt, are unsuccessful. The UE can make another RA attempt unless the configured maximum number of RA attempts has been reached and then the entire RA procedure is declared as unsuccessful.

Upon failure of a RA attempt (due to either no RAR reception, no match for RAPID in RAR with that in Msg1, or failure of contention resolution Msg¾), a UE may perform a new RACH resource selection for a new RA attempt, including selection of a DL RS associated with a PRACH transmission, selection of the PRACH preamble, and selection of the RO. Therefore, it is possible that a different SSB/CSI-RS, and/or a different PRACH preamble, and/or a different RO are used for the PRACH transmission of the new RA attempt compared to the previous RA attempt. However, power ramping is only applied if the same DL RS is used in the PRACH transmissions of the new RA attempt and of the previous RA attempt.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by a system information block (SIB), such as a SIB1, or by a common RRC signaling, or by UE-specific RRC signaling.

In the following, an association between a DL RS, such as a SS/PBCH block (SSB) or a CSI-RS, and a PRACH preamble is with respect to a path-loss determination for computing a power for the PRACH preamble transmission and with respect to quasi-collocation (QCL) properties or a transmission configuration indicator (TCI) state, as described in REF 3.

5G NR radio supports time-division duplex (TDD) operation and frequency division duplex (FDD) operation. Use of FDD or TDD depends on the NR frequency band and per-country allocations. TDD is required in most bands above 2.5 GHz.

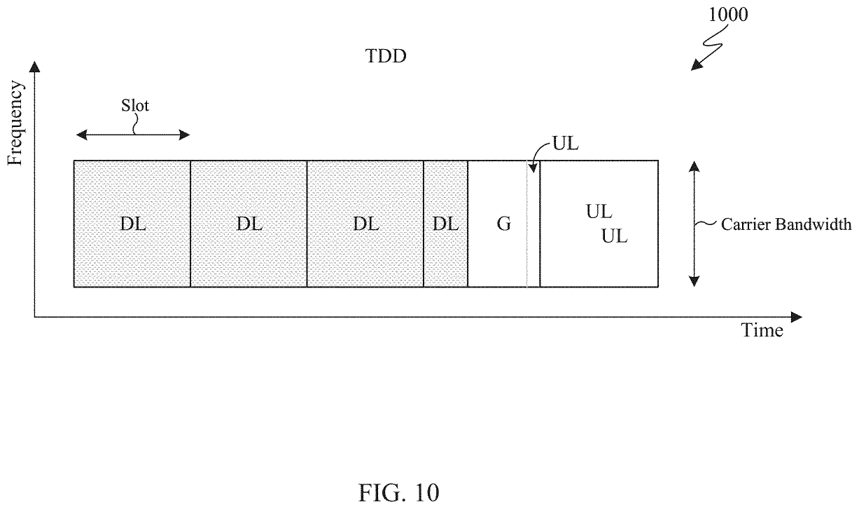

FIG. 10 illustrates an example diagram 1000 of an example structure of slots for a TDD communications system according to the embodiments of the present disclosure. The diagram 1000 is for illustration only and other embodiments can be used without departing from the scope of the present disclosure.

The diagram 1000 describes a DDDSU UL-DL configuration. It is noted that D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the usually small portion of time resources available for UL transmissions, while with FDD all time resources can be used for UL transmissions. Another disadvantage is latency. In TDD, a timing gap between DL reception and UL transmission containing the hybrid automatic repeat request acknowledgement (HARQ-ACK) information associated with DL receptions is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

Embodiments of the present disclosure take into consideration that for addressing some of the disadvantages for TDD operation, a dynamic adaptation of link direction has been considered where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross-link interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a full-duplex wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC.

Furthermore, a gNB (such as the BS 102) can operate with full-duplex mode even when a UE still operates in half-duplex mode, such as when the UE cannot either transmit and receive at a same time, or the UE can also be capable for full-duplex operation.

Full-duplex transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel CLI and self-interference. CLI and self-interference cancelation methods include passive methods that rely on isolation between transmit and receive antennas, active methods that utilize RF or digital signal processing, and hybrid methods that use a combination of active and passive methods. Filtering and interference cancelation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, Cross-Division-Duplex (XDD) is used as a short form for a full-duplex operation. The terms XDD and full-duplex are interchangeably used in the disclosure.

Full-duplex operation in NR can improve spectral efficiency, link robustness, capacity, and latency of UL transmissions. In an NR TDD system, UL transmissions are limited by fewer transmission opportunities than DL receptions. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any UL transmission can only occur in a limited number of UL slots, for example every 2, 2.5, or 5 msec, respectively.

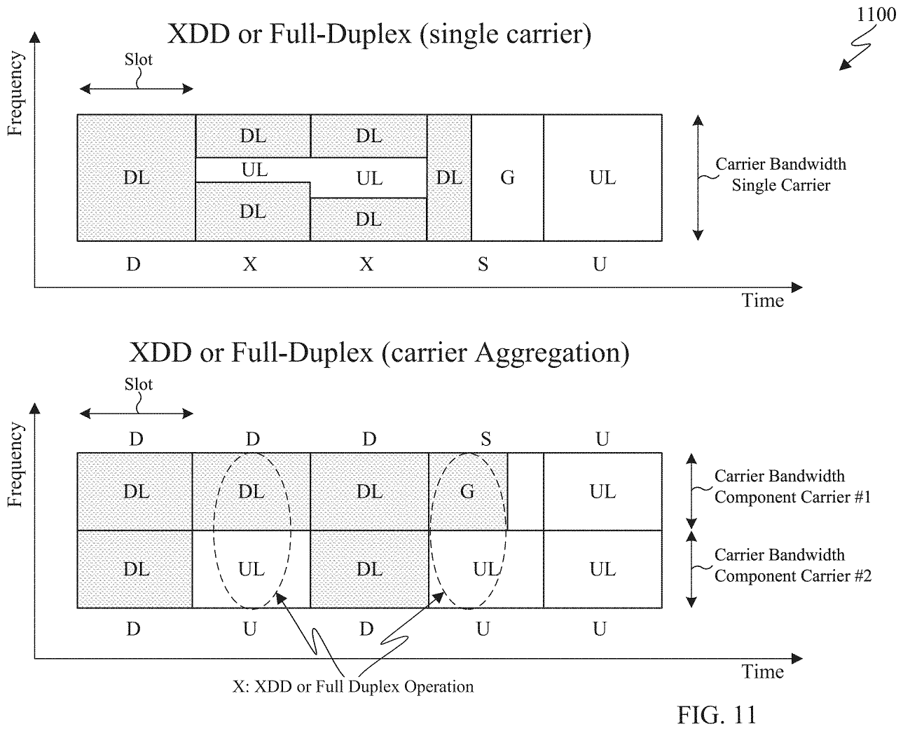

FIG. 11 illustrates an example diagram 1100 of two example full-duplex configurations according to embodiments of the present disclosure. The diagram 1100 is for illustration only and other embodiments can be used without departing from the scope of the present disclosure.

For a single carrier TDD configuration with full-duplex enabled, slots denoted as X are full-duplex or XDD slots. Both DL and UL transmissions can be scheduled in XDD slots for at least one or more symbols. The term XDD slot is used to refer to a slot where UEs can simultaneously both receive and transmit in at least one or more symbols of the slot if scheduled or assigned radio resources by the base station. A half-duplex UE cannot both transmit and receive simultaneously in an XDD slot or on a symbol(s) of an XDD slot. When a half-duplex UE is configured for transmission in symbols of an XDD slot, another UE can be configured for reception in the symbols of the XDD slot. A full-duplex UE can transmit and receive simultaneously in symbols of an XDD slot, possibly in presence of other UEs scheduled or assigned resources for either DL or UL in the symbols of the XDD slot. Transmissions by a UE in a first XDD slot can use same or different frequency-domain resources than in a second XDD slot, wherein the resources can differ in bandwidth, a first RB, or a location of the center carrier.

For a dual-carrier (carrier aggregation) TDD configuration with full-duplex enabled, a UE receives in a slot on CC#1 and transmits in at least one or more symbol(s) of the slot on CC#2. In addition to D slots used only for transmissions/receptions by a gNB/UE, U slots used only for receptions/transmissions by the gNB/UE, and S slots for also supporting DL-UL switching, full-duplex slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for full-duplex operation. UL transmissions can also occur in a last slot (U) where the full UL transmission bandwidth is available. XDD slots or symbol assignments over a time period/number of slots can be indicated by a DCI format in a PDCCH reception and can then vary per unit of the time period, or can be indicated by higher layer signaling, such as via a MAC CE or RRC.

It is noted that a robust network operation uses UEs (such as the UE 116) that are able to establish a connection to the network over a large coverage area without consuming a large amount of resources and without requiring large latency to establish the connection. Therefore, embodiments of the present disclosure take into consideration that there is a need to increase a signal to interference and noise ratio (SINR) for PRACH receptions at a gNB (such as the BS 102) in order to increase PRACH coverage. Embodiments of the present disclosure also take into consideration that there is a need to dimension PRACH capacity in a cell area to achieve a target collision probability for PRACH transmissions from UEs for an expected number of concurrent multiple access attempts by UEs. Embodiments of the present disclosure further take into consideration that need to reduce a delay incurred during a RA procedure due to UL-DL frame alignment delay that represents a delay until a next PRACH transmission opportunity occurs.

When considering that multiple channels and signals need to be transmitted by UEs, PRACH transmissions require several operational restrictions. RBs in UL slots or symbols fully or partially occupied by transmissions of PRACH preambles cannot be typically used for other transmissions, such as for PUSCH. For example, in NR, transmissions of short PRACH preambles prevent M*12 RBs per RO in frequency division multiplexing (FDM) from being used for PUSCH transmissions. Long preambles occupy M*6 or M*24 RBs for 15 kHz SCS, and M*3 or M*12 RBs for 30 kHz SCS, where M=1 . . . 8. A first consequence is a reduction in an absolute number of schedulable UL RBs in an UL slot (U) and a corresponding reduction in UL peak data rates. A second consequence is that, depending on a placement of RACH opportunities in a carrier bandwidth, a PUSCH transmission cannot be allocated a large contiguous BW. In NR Rel-15, UEs are mandated to support only UL resource allocation type 1 that requires frequency-contiguous PUSCH allocations. Therefore, a PUSCH frequency allocation can only be either completely below or completely above the PRACH allocation BW and PUSCH cannot be scheduled in frequency across the ROs. Even if a UE implementation complexity is increased to support UL resource allocation type 0 using RBG-based allocations, additional power back-off of up to several dBs is required for corresponding PUSCH transmissions. This results in substantial data rate reductions due to a lower SINR operating point.

Embodiments of the present disclosure addresses the above issues by enabling PRACH transmission in full-duplex time-domain resources, such as in slots or symbols supporting simultaneous receptions and transmissions by a UE or by a gNB.

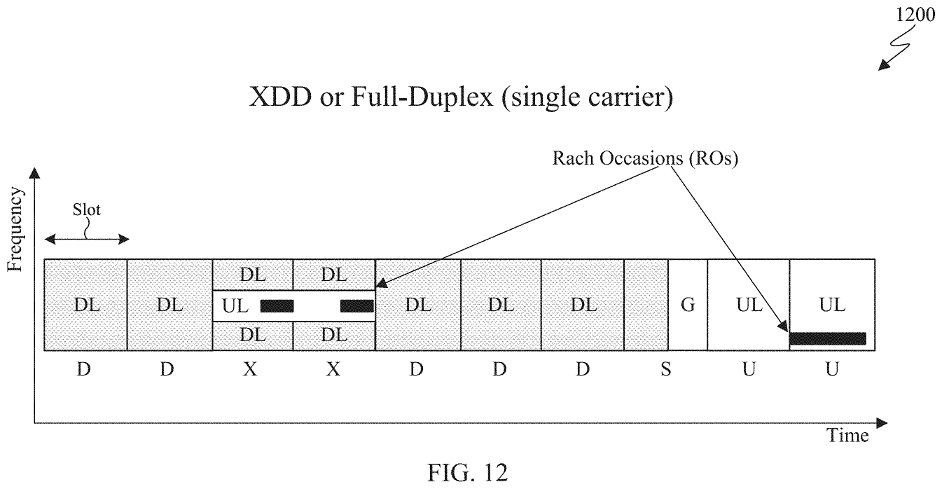

FIG. 12 illustrates an example diagram 1200 of an example RACH configuration using XDD according to embodiments of the disclosure. The diagram 1200 is for illustration only and other embodiments can be used without departing from the scope of the present disclosure.

PRACH preamble transmissions are configured in the third and fourth XDD slot in addition to the last UL slot (U). Generally, transmissions related to an RA procedure, including some or all of Msg1 through Msg4 and possible repetitions, may be enabled in symbols of XDD slot(s). A first PRACH transmission in an XDD slot may be followed by a second PRACH transmission in an UL slot (U), or the reverse.

A first motivation for fully or partially placing PRACH transmissions in XDD slots is to increase a data rate in U slots because an absolute number of schedulable RBs is increased and a large number of contiguous RBs can be allocated to a UE by removing RBs allocated to PRACH preambles. A second motivation is a capability to have larger contiguous RB allocations for PRACH transmissions. For TDD and SCS=30 kHz, only short PRACH preamble formats can be used when a single UL slot (U) is available. Longer PRACH preamble formats necessarily require more than one slot. By allowing PRACH transmissions in N consecutive slots that include XDD slots and can also include UL slots, such as N=2 or N=4 slots, long PRACH preamble formats can be used, thereby increasing a range and achievable accuracy of timing estimation for PRACH receptions. A third motivation is a reduced base station complexity. When one or more UEs transmit respective PUSCHs in an XDD slot, interference cancellation from DL signals needs to be designed for reception of UL signals that can have substantially different transmission bandwidth or MCS settings, such as for receptions of PUSCHs from different UEs that can be at different power levels at the base station receiver or use different MCS for corresponding transport blocks. Transmission of PRACH preambles in an XDD slot only requires a base station to perform interference cancellation based on one specific signal type, such as a Zadoff-Chu sequence used as PRACH preamble, thereby simplifying implementation of interference cancellation. A fourth motivation is that even when PRACH resources are configured in XDD slots, the PRACH resources are only used when UEs actually transmit respective PRACHs. In several cases, depending on RACH dimensioning, no PRACH transmission would occur in an XDD slot where PRACH transmissions are configured. Therefore, provisioning PRACH resources in XDD slots would often not create DL-UL interference.

When considering resource selection and parameterization in time, frequency and power domains of PRACH resources with full-duplex operation in XDD slots, several issues need to be overcome. A first issue relates to processing delays and signal distortions incurred by a serial interference cancelation (SIC) receiver at a base station for fully or partially removing interference from concurrent transmissions on received signals such as PRACH preambles. SIC processing can create additional time delayed responses due to RF and BB filtering and can incur signal energy losses due to FFT misalignment that impacts PRACH reception reliability in XDD slots.

A second issue relates to a need to account for different link conditions for Msg1 and Msg3 transmissions in normal UL slots and in XDD slots. Similar, Msg2 and Msg4 receptions by a UE can be subject to unequal and different reception conditions in XDD slots, where concurrent transmissions from other UEs can exist in some symbols, and in normal DL slots where concurrent transmissions from other UEs cannot exist in any symbols. Those different reception conditions are due to antenna and panel design and deployment constraints. The number of TRX chains for transmission or reception, or areas for transmission or reception antennas available in normal DL or UL slots versus XDD slots, can be different between full-duplex implementations and half-duplex implementations. This is due to antenna design constraints to achieve sufficient spatial isolation between the Tx and Rx antenna ports in full-duplex operation. For example, receptions at a base station in normal UL slots may benefit from 32 TRX using a 12V×8H×2P panel of size 40×60 cm, whereas receptions at the base station in XDD slots may only use 16 TRX and a part or panel with half size than the one in UL slots.

A third issue relates to constraints arising from a need for coexistence with legacy UEs. Using existing state-of-the-art operation when in RRC_IDLE or RRC_INACTIVE mode, all UEs acquire a same set of RACH configuration parameters from a SIB1 as by cell (re-)selection procedures. Therefore, it is not currently possible to assign distinct RACH configurations to legacy UE and to UEs supporting XDD operation.

A fourth issue relates to constraints arising from currently possible RACH frame, subframe(s), slot(s) and starting symbol(s) allocations. Not all possible combinations can currently be assigned using TDD mapping tables for frequency range 1 (FR1) corresponding to carrier frequencies below 6 GHz. For example, it is not possible to assign RACH in slot(s) 3-7 or 5-6. This is due to an assumption that only a limited number of PRACH transmission opportunities are available in TDD. However, with full-duplex operation, more UL transmission opportunities exist, and existing RACH configurations then become unnecessarily restrictive.

Embodiments of the present disclosure addresses the above issues and provides additional design aspects for supporting a random-access procedure where some or all associated messages are transmitted either in full or in part in XDD slots, and provides solutions as fully elaborated in the following.

The disclosure considers methods for random access resource selection, determination and selection of PRACH configurations, determination and validation of ROs, and determination of RACH time-domain frame, slot and starting symbol allocations.

In the following and throughout the disclosure, some configurations, scheduling or resource assignments by a gNB may assume knowledge in the gNB that a UE supports XDD specific provisions. For example, a UE may signal to the gNB through the UE Capability Enquiry procedure that it supports XDD specific provisions. The gNB may also signal XDD specific configurations, scheduling or resource assignments using common DL signalling such as SI. When ASN.1 extensions are used, legacy UEs will ignore such configurations whereas UEs supporting XDD specific provisions may use either or both legacy and XDD configurations. A gNB (such as the BS 102) may also derive knowledge of XDD specific provisions supported by a UE by other means, e.g., implicitly. For example, the gNB may derive knowledge that a particular UE supports XDD-specific provisions because the UE uses a set of designated and known (to the gNB) XDD radio resources.

Accordingly, embodiments of the present disclosure describe methods for resource selection and determination of PRACH resources by a UE (such as the UE 116) in full-duplex enabled wireless systems. Embodiments of the present disclosure describe RSRP based PRACH resource selection procedure differentiating in time-domain (RACH slots & symbol groups) if normal versus full-duplex slots are used for RACH Msg1. Embodiments of the present disclosure also describe multiple RACH configurations provided to UE including possibility of using different target Rx power levels for use in normal (full) UL slots versus full-duplex slots. Embodiments of the present disclosure further describe network-controlled, and UE determined masking of RACH occasions to selectively enable/disable configured ROs for use in full-duplex slots. Additionally, embodiments of the present disclosure describe additional time-domain allocations for TDD RACH to enable access to full-duplex slots which in the conventional TDD system would be DL only.

In certain embodiments, PRACH preamble transmissions configured by RACH configuration in symbols of XDD slot(s) are associated with an RSRP threshold. The UE (such as the UE 116) determines if PRACH preamble transmission is allowed in symbols of an XDD slot, or if an RO is valid, as a function of the RSRP threshold.

A first RSRP threshold for an XDD slot can be same as or different than a second RSRP threshold in full UL slots, if the second RSRP threshold is provided. RSRP threshold(s) can be associated with a measurement based on a received SSB or CSI-RS. A UE (such as the UE 116) can derive the measurement using one or more samples obtained from one or more measurement instances, the measurement may be averaged or filtered, or an instantaneous sample value may be used. The RSRP threshold can be fixed in the specifications or be provided by higher layers, such as by a first system information block (SIB1). The RSRP threshold can be signaled through MAC CE. The RSRP threshold can be an absolute value, or an offset value signaled with respect to another RSRP threshold value, such as an RSRP value for PRACH transmissions on a primary UL carrier or a supplementary UL carrier. For a PRACH transmission with repetitions, different RSRP ranges can be associated with same numbers of repetitions in an XDD slot and in a full UL slot, or different numbers of repetitions can be associated with same RSRP ranges in an XDD slot and in a full UL slot. The association can be provided, for example, by a SIB 1. The association may be applied to a slot, a symbol, or set of slots and symbols. The association may apply at a given timing relationship, for example for same slot or for later slots or symbols. A motivation is to adjust UL coverage and PRACH link budget during random access procedure by a UE in XDD slots. PRACH transmissions received by a base station in XDD slots and normal UL slots can experience different link conditions due to possibly different beamforming and/or processing gains at the base station. The embodiment can apply before and/or after a UE operates in RRC connected mode and/or may be provided by UE-specific or common configurations.

For example, when FR1 unpaired spectrum (TDD) random access configuration with PRACH configuration index 81 is configured, subframe numbers 4, 9 in every frame can include ROs using 6 A1 2-symbol groups starting at symbol 0. For SCS=30 kHz, slot numbers 8 and 18 are therefore configured for ROs and can support PRACH transmissions. When the first slot is an XDD slot and the second slot is a normal UL slot, first and second RSRP thresholds are configured for the first and second slots, respectively. A larger RSRP threshold value can be configured for the first slot to account for lower Rx beamforming gains with fewer available TRX for reception in an XDD slot.

The RSRP threshold associated with Msg1 transmission can be same for a set of slots or symbols, such as XDD slots or UL slots, or Flexible symbols or UL symbols, and for PRACH preamble types and RO configurations. In another example, the RSRP threshold can include multiple settings to be used for a set of slots or symbols, such as XDD slots or UL slots, or Flexible symbols or UL symbols, and for PRACH preamble types and RO configurations.

For another example, an RSRP threshold associated with Msg1 transmission can be used to validate or to de-validate ROs. If the RSRP threshold associated with an SSB or CSI-RS exceeds a predetermined level, a RO in an XDD slot may be used for random access. If the RSRP threshold does not exceed the predetermined level, only ROs meeting a selected condition are valid for PRACH transmission. For example, a first subset of slots is allowed for random access, but a second subset of slots is not allowed. The predetermined level can be provided by the specifications of system operation or can be provided by higher layers such as by system information.

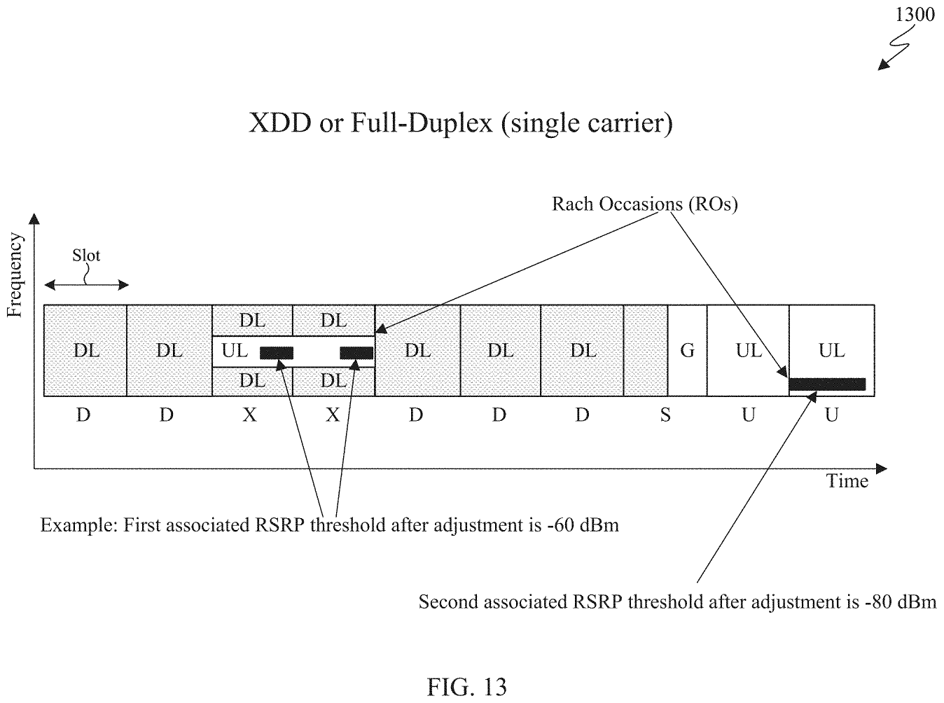

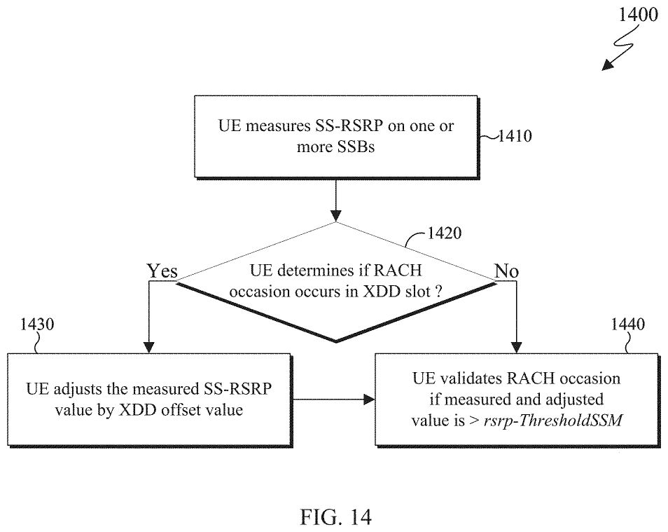

FIG. 13 and FIG. 14 illustrate an example PRACH resource selection processing chain according to embodiments of the disclosure. In particular, FIG. 13 illustrates an example an example diagram 1300 of PRACH resource selection configuration using RSRP according to embodiments of the present disclosure. FIG. 14 illustrates an example method 1400 for PRACH resource selection processing chain using RSRP according to embodiments of the present disclosure. The steps of the method 1400 of FIG. 14 can be performed by any of the UEs 111-116 of FIG. 1, such as the UE 116 of FIG. 3. The diagram 1300 and the method 1400 are for illustration only and other embodiments can be used without departing from the scope of the present disclosure.

In certain embodiments, a UE (such as the UE 116) determines one or more RSRP threshold offset values for random access resource selection. A random-access resource can comprise one or more ROs allocated in symbols of XDD slots. The UE measures an RSRP for one or more received SSB indices or NZP CSI-RS configurations. The UE determines if an RO occurs in a full/normal UL slot, or in an XDD slot. If the RO occurs in a full/normal UL slot, the UE validates the RO when there is an SSB with SS-RSRP above rsrp-ThresholdSSB. If the RO occurs in an XDD slot, the UE validates the RO only when there is an SSB with SS-RSRP above rsrp-ThresholdSSB+ offset_{xdd}. An offset_{xdd} value can be provided by higher layers such as by a first system information block (SIB 1), for example by a same element providing rsrp-ThresholdSSB. Alternatively, instead of offset_{xdd}, higher layers can provide a parameter rsrp-ThresholdSSB-XDD and the UE validates the RO only when there is an SSB with SS-RSRP above rsrp-ThresholdSSB-XDD.

As illustrated in FIG. 14, in step 1410, a UE (such as the UE 116) measures SS-RSRP on one or more SSBs. In step 1120, the UE determines whether RO occurs in XXD slot. When the RO occurs in XXD slot (as determined in step 1420), the electronic device, in step 1430, adjusts the measured SS-RSRP value by XDD offset value. When the RO does not occur in XXD slot (as determined in step 1420) or after the UE adjusts the measured SS-RSRP value by XDD offset value (when the RO occurs in XXD slot, as determined in step 1420), the electronic device, in step 1440 validates the RO if measured and adjusted value is greater than a threshold denoted as rsrp-ThresholdSSB.

Although FIG. 14 illustrates the method 1400 various changes may be made to FIG. 14. For example, while the method 1400 is shown as a series of steps, various steps could overlap, occur in parallel, occur in a different order, or occur multiple times. In another example, steps may be omitted or replaced by other steps. For example, steps of the method 1400 can be executed in a different order.

In certain embodiments, a UE (such as the UE 116) determines and selects an applicable RACH configuration for transmission of PRACH preambles from a set of candidate RACH configurations.

A RACH configuration can be provided by higher layers via common RRC signaling, such as by system information, or via UE-specific RRC signaling. Information can also include conditions for using the RACH configuration. The embodiment can apply before and/or after a UE operates in RRC connected mode. A RACH configuration can be provided by RRC and activated or deactivated using a MAC CE. A first and a second RACH configuration can differ in at least one configuration parameter. A RACH configuration includes at least one, a combination of some, or all of the following configuration parameters. A parameter denoted as ‘prach-ConfigurationIndex’ represents the available set of PRACH occasions for transmission of a Random-Access Preamble. A parameter denoted as A parameter denoted as ‘preambleReceivedTargetPower’ represents initial Random Access Preamble power. A parameter denoted as ‘rsrp-ThresholdSSB’ represents an RSRP threshold for an SSB selection. A parameter denoted as ‘rsrp-ThresholdCSI-RS’ represents an RSRP threshold for a CSI-RS selection. A parameter denoted as ‘candidateBeamRSList represents a list of reference signals (CSI-RS and/or SSB) identifying candidate beams for recovery and associated Random Access parameters. A parameter denoted as ‘recoverySearchSpaceId’ represents a search space set identity for monitoring PDCCH for detection of a DCI format providing response to a beam failure recovery request. A parameter denoted as ‘powerRampingStep’ represents a power-ramping factor. A parameter denoted as ‘powerRampingStepHighPriority’ represents a power-ramping factor for a prioritized Random-Access procedure. A parameter denoted as ‘scalingFactorB1’ represents a scaling factor for a prioritized Random-Access procedure. A parameter denoted as ‘ra-PreambleIndex’ represents a Random-Access Preamble. A parameter denoted as ‘ra-ssb-OccasionMaskIndex’ defines PRACH occasions, associated with an SSB, that the MAC entity can choose from for transmission of a Random-Access Preamble by the physical layer. A parameter denoted as ‘ra-OccasionList’ defines PRACH occasion(s), associated with a CSI-RS, that the MAC entity can choose from for transmission of a Random-Access Preamble by the physical layer. A parameter denoted as ‘ra-PreambleStartIndex’ represents a starting index of Random-Access Preamble(s) for on-demand SI request. A parameter denoted as ‘preambleTransMax’ represents a maximum number of Random-Access Preamble transmissions. A parameter denoted as ‘ssb-perRACH-OccasionAndCB-PreamblesPerSSB’defines a number of SSBs mapped to each PRACH occasion and a number of contention-based Random-Access Preambles mapped to each SSB. A parameter denoted as ‘groupBconfigured’ represents an indication of whether or not Random-Access Preambles group B is configured. A parameter denoted as ‘ra-Msg3SizeGroupA’ represents a threshold used to determine groups of Random-Access Preambles. A parameter denoted as ‘msg3-DeltaPreamble’ represents APREAMBLE_Msg3. A parameter denoted as ‘messagePowerOffsetGroupB’ represents a power offset for preamble selection. A parameter denoted as ‘numberOfRA-PreamblesGroupA’ defines a number of Random Access Preambles in Random Access Preamble group A for each SSB such as (i) a set of Random Access Preambles and/or PRACH occasions for SI request, if any; (ii) a set of Random Access Preambles and/or PRACH occasions for beam failure recovery request, if any; (iii) a set of Random Access Preambles and/or PRACH occasions for reconfiguration with sync. A parameter denoted as ‘ra-ResponseWindow’ represents a time window to monitor RA response(s). A parameter denoted as ‘ra-ContentionResolutionTimer’ represents a Contention Resolution Timer. A parameter denoted as ‘msg1-FDM’ represents a number of PRACH transmission occasions FDM'ed in one time instance. A parameter denoted as ‘msg1-FrequencyStart’ represents offset of lowest PRACH transmission occasion in frequency domain with respective to physical resource block (PRB) zero. A parameter denoted as ‘powerRampingStep’ represents power ramping steps for PRACH. A parameter denoted as ‘preambleReceivedTargetPower’ represents a target received power level at the base station/network. A parameter denoted as ‘zeroCorrelationZoneConfig’ represents Ncs configuration. Additional parameters can also be part of a RACH configuration.

For example, when FR1 unpaired spectrum (TDD) random access configuration with PRACH configuration index 81 is configured, subframe numbers 4, 9 in every frame can carry ROs using 6 A1 2-symbol groups starting at symbol 0. For SCS=30 kHz, slot numbers 8 and 18 are therefore configured for PRACH transmissions. When the first slot is an XDD slot and the second slot a normal UL slot, a first preambleReceivedTargetPower of −80 dBm is configured by a first RACH configuration for the XDD slots, and a second preambleReceivedTargetPower with maximum possible setting of −60 dBm is configured by a second RACH configuration for the normal/full UL slot. The first and second RACH configurations in this example can be configured to be same except their associated preambleReceivedTargetPower values differ. An association of preambleReceivedTargetPower values with RACH slots or ROs is provided to the UE. Alternatively, a RACH configuration, such as with index 81, is provided to the UE with associated preambleReceivedTargetPower values and their associated slots or ROs. The UE then derives a first RACH configuration by applying the criterion of preambleReceivedTargetPower=−80 dBm and a second RACH configuration by applying the criterion of preambleReceivedTargetPower=−60 dBm.

A motivation is to adjust a received power level at a base station during a random-access procedure by a UE in XDD slots. When a PRACH transmission is received in normal/full UL slots, PRACH detection can be processed by the base station in absence of any DL interference, thereby maximizing UL coverage and using the full processing gains at the base station. A PRACH transmission received and processed by the base station in XDD slots or symbols may be subject to Rx power constraints considering interference cancellation capabilities of the base station. In addition, control of UL-DL cross-link interference generated by a UE transmitting a PRACH preamble and affecting UEs receiving in the DL part of the XDD slot can be facilitated by using a separate power setting in the full-duplex system.

For another example, for FR1 unpaired spectrum random access, a first RACH configuration using PRACH configuration index 77 is provided. Subframe 9 in every frame can include ROs using 6 A1 2-symbol groups starting at symbol 0. For SCS=30 kHz, slot number 18 is therefore configured for PRACH. A second RACH configuration using PRACH configuration index 12 is provided. Subframe 4 (or slot 7) in every frame can include an RO using a long preamble format 0 with 1.25 kHz with a duration of more than one slot. PRACH preamble transmissions in subframe 4 or 9 therefore use different PRACH preambles as provided by the separate RACH configurations. A motivation is to enable UEs not supporting XDD/full-duplex operation to access the cell using short preambles in normal UL slots, while UEs supporting XDD/full-duplex operation can use preamble formats that are more appropriate for the DL-UL interference conditions that transmissions/receptions in XDD slots can be subjected to.

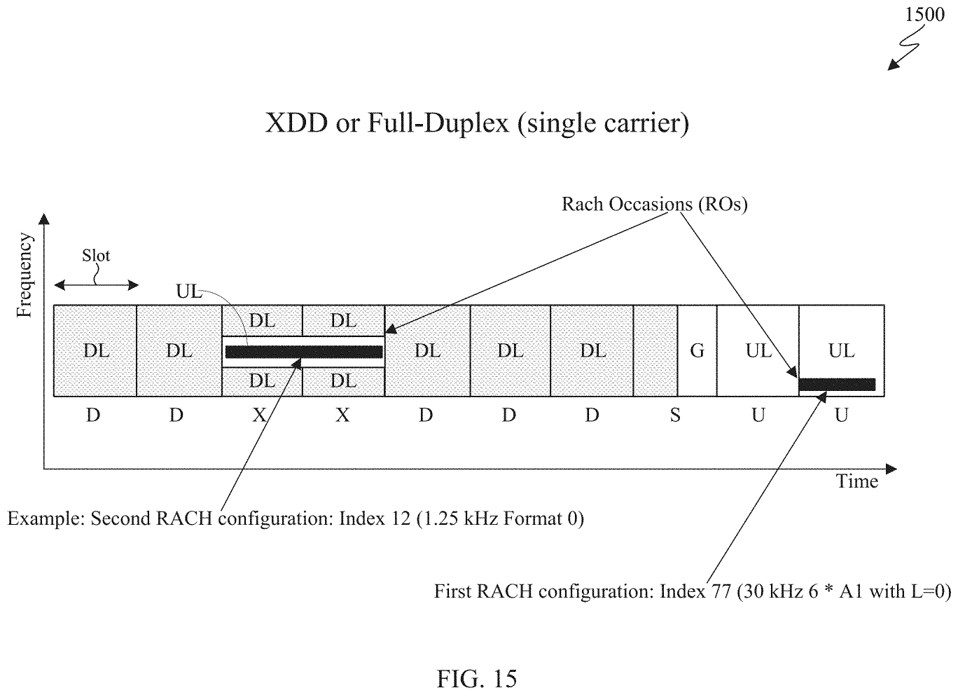

FIG. 15 illustrates an example diagram 1500 of determination for a configuration and use of RACH configurations according to embodiments of the disclosure. The diagram 1500 is for illustration only and other embodiments can be used without departing from the scope of the present disclosure.

A UE (such as the UE 116) determines first and second RACH configurations. The UE selects an applicable RACH configuration depending on the slot or symbols resources available for random access (PRACH preamble transmission). The UE then applies some or all the parameters given by the selected RACH configuration and performs preamble transmission using the selected RACH configuration parameters.

In certain embodiments, the UE (such as the UE 116) validates and/or disables RACH occasions in full-duplex slots or symbols using a bitmap provided by a serving base station, such as by system information, or using selected rules.

For example, when FR1 unpaired spectrum random access configuration with PRACH configuration index 81 is configured, subframe numbers 4, 9 in every frame can include ROs using 6 A1 2-symbol groups starting at symbol 0. For SCS=30 kHz, slot numbers 8 and 18 are therefore configured for PRACH. When the first slot is an XDD slot and the second slot a normal UL slot, the UE applies a bitmap to determine time-domain ROs that are valid for PRACH transmission in the first XDD slot 8. For example, a bitmap of size 6 and a bitmap value of “010101”, where “1” represents an “allowed” RO and “0” represents a “disallowed” RO, disables every second RO in slot 8.

For another example, when FR1 unpaired spectrum random access is used, a RACH configuration using PRACH configuration index 108 is provided. Subframes 1, 3, 5, 7, 9 (or slots 2, 6, 10, 14, 18) in every frame can include ROs using 3 A2 4-symbol groups starting at symbol 0. For example, a bitmap of size 5 and with value “11110”, where “1” represents an “allowed” RO and “0” represents a “disallowed” RO, disables all ROs in slot 18.

A motivation is to simplify a base station implementation for interference cancellation and improve a PRACH reception reliability in full-duplex slots. Base station interference cancellation removes interference from a transmitted DL signal including non-linear distortions introduced by the base station transmitter RF from the received UL signal during full-duplex operation. This creates filter responses affecting samples of following received OFDM symbols. SINR of the received UL signal is degraded. In the case of random access, a RO, such as a preceding symbol group, can distort a signal reception in a next following RO, such as a symbol group. For common PRACH detection implementations, there are constraints with respect to the placement of FFT window sizes and accumulation of detected energy levels across symbols when processing received RACH preambles in an RO. By disabling certain ROs, it becomes easier for a base station receiver to implement DTX detection (determine absence of received signal) and enable reliable PRACH detection when timing uncertainties are more than 1 symbol. Both a coherent detector and a non-coherent detector can be implemented by the base station receiver.

One or more bitmaps, of fixed or indicated lengths, can be signaled to a UE (such as the UE 116), for example by system information or by UE-specific RRC. A bitmap is applicable only to slots that include ROs where each bit represents one time-domain RO, or ROs over more than one RACH slot. Multiple bitmaps can be used to determine valid ROs, a first bitmap per-symbol group per slot, a second bitmap per slot for a RACH configuration. Bitmaps can have varying lengths that are predetermined in the specifications of the system operation or are signaled by common or UE-specific RRC. For example, a bitmap validating a 6 RO per slot configuration with 2 symbols per RO can be 6 bits long, while a bitmap validating a single 6-symbol group starting at symbol 7 can be 1 bit long.

Alternatively, specified rules can be used by a UE to validate ROs. For example, every second RO in an XDD slot configured for RACH is not allowed and is invalidated. For example, every N^{th} RO starting from RO #M is disabled. ROs can be validated in both time and frequency domains. For example, a bitmap can validate or invalidate ROs across the RACH frequency-domain allocation in a slot. The values and numbers of bitmaps to validate and process ROs can be signaled to the UE by higher layers, such as by RRC or MAC CEs. The higher layer signaling can be UE-specific or common to all UEs. Conditions can apply in RRC_IDLE, RRC_INACTIVE, and RRC_CONNECTED modes.

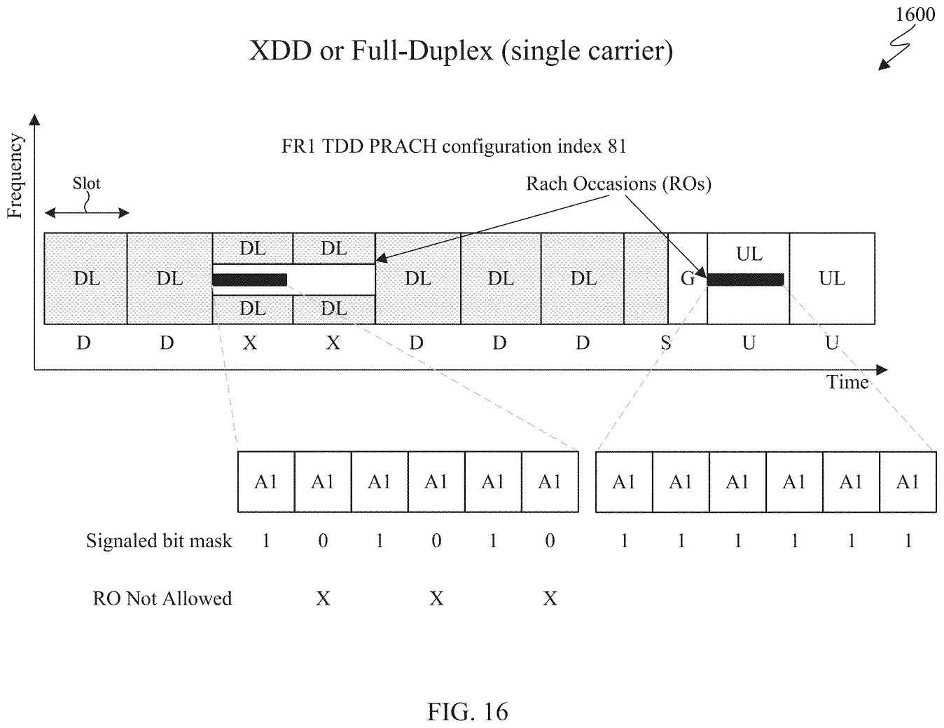

FIG. 16 illustrates an example PRACH allocation and configuration according to embodiments of the disclosure. The diagram 1600 is for illustration only and other embodiments can be used without departing from the scope of the present disclosure.

A UE determines at least one RO masking bitmap. The UE applies the RO masking bitmap depending on whether or not a selected slot or symbol configured for PRACH is used for full-duplex transmissions. The UE randomly selects a RO from the remaining set of allowed ROs for a PRACH preamble transmission.

In certain embodiments, a UE is configured with a different set of RACH frame, subframe, slot and starting symbol mappings to determine applicable RACH subframes, RACH slots and starting symbols for PRACH preamble transmission in full-duplex slots.

RACH frames, subframes, slots or starting symbols may be obtained as additional index values for the parameter prach-Configurationlndex, or by use of a second mapping table, or by use of the parameter prach-Configurationlndex from an existing mapping table and then by re-mapping the obtained values using a fixed or tabulated set or configurable set of subframe, slot or symbol offset values. For example, the FR1 (or FR2) mapping table for use by a TDD UE can be configured by using the FR1 (or FR2) FDD mapping table.

The following examples use the A1 preamble formats from REF1 Table 6.3.3.2.-3 shown in Table (2) for illustration purposes. In particular, Table (2) describes preamble A1 format configuration FR1 TDD. For the specific case of RACH frame, subframe and slot mappings of (non-mixed) A1 preamble formats, the shown allocations cases in Table (2) are currently possible by NR specifications. However, same design considerations can be directly extended to other preamble formats such as 0, 1, 2, 3 or A1, A2, A3, B1, B4, C0, C2 or any mixed formats that are not shown, as evident to someone skilled in the art.

For example, an alternative mapping table is provided to a UE by higher layers for use in full-duplex slots. For example, Table (3) shows an alternative set of PRACH frame, slot and starting symbol mappings for the A1 formats. RACH frame and slot mappings are located earlier in an UL-DL frame configuration period to account for UL transmission opportunities provided by full-duplex operation in DL slots. For example, index value 73 that is valid for an alternative mapping table as shown in Table 3 allows for PRACH in subframes 5, 6. Therefore, PRACH resources can be allocated to XDD slots in a DDXXDDSUU UL-DL frame allocation. For example, SIB or UE-specific RRC signaling can provide a configuration of such an alternative mapping table. The use of an alternative PRACH mapping table can also depend on whether operation is in RRC_IDLE, or RRC_INACTIVE, or RRC_CONNECTED mode.

TABLE (2)

| PRACH | | | | | | Number of |
|---|---|---|---|---|---|---|
| Configuration | Preamble | n_{SFN} mode x = y | | Subframe | Starting | PRACH slots |
| Index | format | x | y | number | symbol | within a subframe |
| 67 | A1 | 16 | 1 | 9 | 0 | 2 |
| 68 | A1 | 8 | 1 | 9 | 0 | 2 |
| 69 | A1 | 4 | 1 | 9 | 0 | 1 |
| 70 | A1 | 2 | 1 | 9 | 0 | 1 |
| 71 | A1 | 2 | 1 | 4, 9 | 7 | 1 |
| 72 | A1 | 2 | 1 | 7, 9 | 7 | 1 |
| 73 | A1 | 2 | 1 | 7, 9 | 0 | 1 |
| 74 | A1 | 2 | 1 | 8, 9 | 0 | 2 |
| 75 | A1 | 2 | 1 | 4, 9 | 0 | 2 |
| 76 | A1 | 2 | 1 | 2, 3, 4, 7, 8, 9 | 0 | 1 |
| 77 | A1 | 1 | 0 | 9 | 0 | 2 |
| 78 | A1 | 1 | 0 | 9 | 7 | 1 |
| 79 | A1 | 1 | 0 | 9 | 0 | 1 |
| 80 | A1 | 1 | 0 | 8, 9 | 0 | 2 |
| 81 | A1 | 1 | 0 | 4, 9 | 0 | 1 |
| 82 | A1 | 1 | 0 | 7, 9 | 7 | 1 |
| 83 | A1 | 1 | 0 | 3, 4, 8, 9 | 0 | 1 |
| 84 | A1 | 1 | 0 | 3, 4, 8, 9 | 0 | 2 |
| 85 | A1 | 1 | 0 | 1, 3, 5, 7, 9 | 0 | 1 |
| 86 | A1 | 1 | 0 | 0-9 | 7 | 1 |

For another example, the exemplary values shown in Table (3) can be indicated by additional or extended set of index values for the parameter prach-Configurationlndex. In particular, Table (3) describes a preamble A1 format configuration for FR1 TDD using an alternative mapping table. For example, using the 8 bits of the existing prach-Configurationlndex and providing an additional 3 bits of prach-ConfigurationlndexExt, the combinations 67-86 from Table (3) are indicated as index values 256+(67, . . . , 86)=323, . . . , 342.

TABLE (3)

| | | | | | | Number of |
|---|---|---|---|---|---|---|
| PRACH | | | | | | PRACH slots |
| Configuration | Preamble | n_{SFN} mode x = y | | Subframe | Starting | within a |
| Index | format | x | y | number | symbol | subframe |
| 67 | A1 | 16 | 1 | 4 | 0 | 2 |
| 68 | A1 | 8 | 1 | 4 | 0 | 2 |
| 69 | A1 | 4 | 1 | 4 | 0 | 1 |
| 70 | A1 | 2 | 1 | 4 | 0 | 1 |
| 71 | A1 | 2 | 1 | 3, 4 | 7 | 1 |
| 72 | A1 | 2 | 1 | 4, 5 | 7 | 1 |
| 73 | A1 | 2 | 1 | 5, 6 | 0 | 1 |
| 74 | A1 | 2 | 1 | 7, 8 | 0 | 2 |
| 75 | A1 | 2 | 1 | 8, 9 | 0 | 2 |
| 76 | A1 | 2 | 1 | 2-3, 6-7, 9 | 0 | 1 |
| 77 | A1 | 1 | 0 | 4 | 0 | 2 |
| 78 | A1 | 1 | 0 | 4 | 7 | 1 |
| 79 | A1 | 1 | 0 | 4 | 0 | 1 |
| 80 | A1 | 1 | 0 | 3, 4 | 0 | 2 |
| 81 | A1 | 1 | 0 | 4, 5 | 0 | 1 |
| 82 | A1 | 1 | 0 | 5, 6 | 7 | 1 |
| 83 | A1 | 1 | 0 | 3-4, 6-7 | 0 | 1 |
| 84 | A1 | 1 | 0 | 3-4, 6-7 | 0 | 2 |
| 85 | A1 | 1 | 0 | 1-5 | 0 | 1 |
| 86 | A1 | 1 | 0 | 0-9 | 7 | 1 |

For another example, higher layers can provide one or more offset or adjustment values to determine frame, subframe slot and starting symbol mappings. For example, a frame offset X1, subframe offset X2, slot offset X3 and starting symbol offset X4 can be provided to the UE in conjunction with an existing prach-Configurationlndex N. Upon reception of the PRACH configuration index value N, for example N=73, the UE can determine subframes 7 and 9 as providing PRACH allocations. When a set of adjustment values (X1=0, X2=2, X3=0, X4=0) is signaled to the UE, subframe locations (7-X2, 9-X2)=(5, 7) are used for PRACH transmissions in XDD slots. All other parameters, such as frame, number of slots, starting symbol derived from the table are unchanged in this example. Alternatively, such applicable relative configuration parameters can be fixed in the system specifications. Multiple sets of adjustment values can be used, either through signaling or through an indexed set. Also, use of a particular set of adjustment values can be subjected to and occur only when certain transmission conditions apply, such as when certain Tx or Rx power levels are fulfilled.

A motivation is to distribute PRACH transmissions from UEs in subframe(s) and slot(s) enabled by the use of full-duplex in a cell and increase available UL transmission resources in normal/full UL slots for PUSCH transmissions, thereby enabling an increase in achievable UL data rates.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving:
first information for first parameters of a first random-access channel (RACH) configuration associated with a first subset of slots from a set of slots on a cell, and
second information for second parameters of a second RACH configuration associated with a second subset of slots from the set of slots on the cell;
determining a RACH configuration, among the first and second RACH configurations, for a physical random-access channel (PRACH) transmission in a slot on the cell based on whether the slot is from the first subset of slots or the second subset of slots; and
transmitting the PRACH in the slot on the cell based on the determined RACH configuration.

2. The method of claim 1, wherein:
a slot from the first subset of slots is not indicated for simultaneous transmission and reception during a same time-domain resource on a cell, and
a slot from the second subset of slots is indicated for simultaneous transmission and reception during a same time-domain resource on the cell.

3. The method of claim 1, further comprising:
identifying a first parameter of the first RACH configuration; and
determining a second parameter of the second RACH configuration based on the first parameter and an adjustment value included in the second information,
wherein transmitting the PRACH in the slot further comprises transmitting the PRACH in the slot based on the second parameter.

4. The method of claim 1, wherein determining the RACH configuration further comprises selecting the RACH configuration for transmission of the PRACH in the slot based on a configurable signal power or signal quality threshold for the first or second subset of slots that includes the slot.

5. The method of claim 1, wherein receiving the second information comprises receiving the second information in a system information block (SIB1).

6. The method of claim 1, further comprising:
determining, based on at least one of the first and second information:
a first set of parameters associated with power ramping of the PRACH transmission in the slot when the slot is in the first subset of slots, and
a second set of parameters associated with power ramping of the PRACH transmission in the slot when the slot is in the second subset of slots.

7. The method of claim 1, further comprising
determining:
a first set of valid random-access occasions (ROs) for the PRACH transmissions in the slot based on the first information, and
a second set of valid random-access occasions (ROs) for the PRACH transmissions in the slot based on the second information; and
selecting an RO from one of the first and second sets of valid ROs associated with the PRACH transmissions,
wherein transmitting the PRACH in the slot further comprises transmitting the PRACH in the selected RO in the slot.

8. A user equipment (UE) comprising:
a transceiver configured to receive:
first information for first parameters of a first random-access channel (RACH) configuration associated with a first subset of slots from a set of slots on a cell, and
second information for second parameters of a second RACH configuration associated with a second subset of slots from a set of slots on a cell; and
a processor operably coupled to the transceiver, the processor configured to determine a RACH configuration, among the first and second RACH configurations, for a physical random-access channel (PRACH) transmission in a slot on the cell based on whether the slot is from the first subset of slots or the second subset of slots,
wherein the transceiver is further configured to transmit the PRACH in the slot on the cell based on the determined RACH configuration.

9. The UE of claim 8, wherein the transceiver is further configured to receive signaling that:
a slot from the first subset of slots is not indicated for simultaneous transmission and reception during a same time-domain resource on a cell, and
a slot from the second subset of slots is indicated for simultaneous transmission and reception during a same time-domain resource on the cell.

10. The UE of claim 8, wherein:
the processor is further configured to:
identify a first parameter of the first RACH configuration, and
determine a second parameter of the second RACH configuration based on the first parameter and an adjustment value included in the second information, and
the transceiver is further configured to transmit the PRACH in the slot based on the second parameter.

11. The UE of claim 8, wherein the processor is further configured to select the RACH configuration for transmission of the PRACH in the slot based on a configurable signal power or signal quality threshold for the first or second subset of slots that includes the slot.

12. The UE of claim 8, wherein the transceiver is configured to receive the second information in a system information block (SIB1).

13. The UE of claim 8, wherein:
the processor is further configured to determine, based on at least one of the first and second information,
a first set of parameters associated with power ramping of the PRACH transmission in the slot when the slot is in the first subset of slots, and
a second set of parameters associated with power ramping of the PRACH transmission in the slot when the slot is in the second subset of slots.

14. The UE of claim 8, wherein:
the processor is further configured to:
determine a first set of valid random-access occasions (ROs) of the PRACH transmissions in the slot based on the first information;
determine a second set of valid random-access occasions (ROs) of the PRACH transmissions in the slot based on the second information; and
select an RO from one of the first and second sets of valid ROs associated with the PRACH transmissions, and
the transceiver is further configured to transmit the PRACH in the selected RO in the slot.

15. A base station comprising:
a transceiver configured to transmit:
first information for first parameters of a first random-access channel (RACH) configuration associated with a first subset of slots from a set of slots on a cell, and
second information for second parameters associated with a second RACH configuration associated with a second subset of slots from the set of slots on the cell; and
a processor operably coupled to the transceiver, the processor configured to determine a RACH configuration for reception of a physical random-access channel (PRACH) in a slot on the cell based on whether the slot is from the first subset of slots or the second subset of slots,
wherein the transceiver is further configured to receive the PRACH in the slot based on the determined RACH configuration.

16. The base station of claim 15, wherein the transceiver is further configured to transmit signaling that:
a slot from the first subset of slots is not indicated for simultaneous transmission and reception during a same time-domain resource on a cell, and
a slot from the second subset of slots is indicated for simultaneous transmission and reception during a same time-domain resource on the cell.

17. The base station of claim 15, wherein:
the processor is further configured to:
identify a first parameter of the first RACH configuration, and
determine a second parameter of the second RACH configuration based on the first parameter and an adjustment value included in the second information, and
the transceiver is further configured to receive the PRACH in the slot based on the second parameter.

18. The base station of claim 15, wherein:
the processor is further configured to determine a signal power or signal quality threshold for the first or second subset of slots that includes the slot to indicate the RACH configuration for transmission of the PRACH in the slot, and
the transceiver is further configured to transmit information indicating the signal power or signal quality threshold.

19. The base station of claim 15, wherein the transceiver is configured to transmit the second information in a system information block (SIB1).

20. The base station of claim 15, wherein:
the processor is further configured to determine, based on at least one of the first and second information,
a first set of parameters associated with power ramping of the PRACH reception in the slot when the slot is in the first subset of slots, and
a second set of parameters associated with power ramping of the PRACH reception in the slot when the slot is in the second subset of slots.
